(19) United States
(12) Patent Application Publication
(10) Pub. No.: US 2016/0269624 A1
(43) Pub. Date: Sep. 15, 2016

(54) Image Photographing Apparatus and Method for Photographing Image Thereof

(71) Applicant: Samsung Electronics Co., Ltd., Suwon-si (KR)

(72) Inventors: Jin-gu JEONG, Seongnam-si (KR); Kyoung-young KIM, Suwon-si (KR); So-hyeong KIM, Suwon-si (KR); Sahng-gyu PARK, Seongnam-si (KR); Yeong-rok LEE, Suwon-si (KR); Hyun-seok HONG, Suwon-si (KR)

(21) Appl. No.: 15/046,248

(22) Filed: Feb. 17, 2016

(30) Foreign Application Priority Data
Mar. 12, 2015 (KR) 10-2015-0034350

(51) Int. Cl. H04N 5/232; H04N 5/14

(52) U.S. Cl. CPC H04N 5/23222; H04N 5/144

(57) ABSTRACT

An image photographing apparatus is provided. The image photographing apparatus includes a photographing unit configured to photograph a plurality of objects and a controller configured to determine a main object to be used as a reference for a photographing operation from among the plurality of objects, set a parameter for the photographing operation based on a motion of the main object, and control the photographing unit to photograph the plurality of objects using the parameter.

### RELATED APPLICATION(S)

This application claims the benefit of priority under 35 U.S.C. §119 from Korean Patent Application No. 10-2015-0034350, filed on Mar. 12, 2015, in the Korean Intellectual Property Office, the disclosure of which is incorporated herein by reference in its entirety.

### BACKGROUND

The present general concept generally relates to an image photographing apparatus and a method for photographing an image thereof, and more particularly, to an image photographing apparatus which appropriately performs automatic setting of a parameter for photographing a plurality of objects which move differently and a method for photographing an image thereof.

As the existing chemical film printing type-analog camera has evolved into a digital camera, the digital camera has provided a user with a convenient and improved photographing function based on the development of diverse and innovative electronic technologies.

Specially, in case of a dynamic sports game or an animal that moves fast, a photographing method of instantaneously catching a moment is needed.

The recent digital camera features a method of rapidly reading out data of an image sensor in a high-speed frame rate, thereby providing a function of clearly photographing a momentary image of a moving object.

However, it is difficult for a common user to learn several parameters of a camera for using such function and control the parameters appropriately when performing a photographing operation.

The digital camera generally provides an Auto Exposure (AE) function in an attempt to assist the user in the photographing operation, but the parameters set through the AE function analyze an image with reference to entire areas or a particular fixed area of a photographed image, and thus, a main object that a user wants may not be photographed rightly.

### SUMMARY

The present disclosure has been provided to address the aforementioned and other photographing operations, and an aspect of the present disclosure provides an image photographing apparatus and a method for photographing an image thereof.

According to an exemplary embodiment, there is provided an image photographing apparatus including: a photographing unit configured to photograph a plurality of objects and a controller configured to determine a main object to be used as a reference for a photographing operation from among the plurality of objects, set a parameter for the photographing operation based on a motion of the main object, and control the photographing unit to photograph the plurality of objects using the parameter.

The controller may analyze a speed at which the main object moves and sets the parameter based on the analyzed speed.

The parameter may include at least one of a shutter speed, an aperture openness (F/#), and sensitivity (ISO).

The controller may perform tracking with respect to the motion of the main object and sets the parameter based on the motion of the main object anticipated at a point of time when the plurality of objects are photographed based on the tracking.

The controller may determine an object corresponding to characteristic information on a pre-stored object from among the plurality of objects as the main object.

The controller may determine one of an object which is a largest object, an object which is photographed for a longest time, an object which is closest to the image photographing apparatus, an object which is located in a centermost position, and an object which is previously photographed from among the plurality of objects as the main object.

In response to selecting one of the plurality of objects, the controller determines the selected object as the main object.

The controller may set the parameter according to a predetermined condition based on different motions of respective parts of the main object.

The controller may provide information on at least one a motion and a pose of the main object visually.

According to an exemplary embodiment, there is provided a method for photographing an image, the method including: determining a main object to be used as a reference for a photographing operation from among a plurality of objects, setting a parameter for the photographing operation based on a motion of the main object, and photographing the plurality of objects using the parameter.

The setting the parameter may include analyzing a speed at which the main object moves and setting the parameter based on the analyzed speed.

The parameter may include at least one of a shutter speed, an aperture openness (F/#), and sensitivity (ISO).

The setting the parameter may include performing tracking with respect to the motion of the main object and setting the parameter based on the motion of the main object anticipated at a point of time when the plurality of objects are photographed by the tracking.

The determining the main object may include determining an object corresponding to characteristic information on a pre-stored object from among the plurality of objects as the main object.

The determining the main object may include determining at least one of a largest object, an object photographed for a longest time, an object closest to the image photographing apparatus, an object located in a centermost position, and an object previously photographed from among the plurality of objects as the main object.

In response to selecting one of the plurality of objects, determining a main object further comprises determining the selected object as the main object.

The setting the parameter may include setting the parameter according to a predetermined condition based on different motions of respective parts of the main object.

The method may further include providing information on at least one a motion and a pose of the main object visually.

According to the above-described various exemplary embodiments, in response to a plurality of objects which move at different speeds, a parameter may be set automatically so as to be suitable for a motion of an object in which a user is interested, and thus, a more improved image quality may be provided.

### BRIEF DESCRIPTION OF THE DRAWINGS

The above and/or other aspects of the present inventive concept will be more apparent by describing certain exemplary embodiments of the present inventive concept with reference to the accompanying drawings, in which:

FIG. 1 is a block diagram illustrating a simple structure of an image photographing apparatus according to an exemplary embodiment;

FIG. 2 is a block diagram illustrating a detailed structure of the image photographing apparatus of FIG. 1;

FIG. 3 is a flow diagram provided to describe an image photographing apparatus by respective functions according to an exemplary embodiment;

FIGS. 4A, 4B, 5A, 5B, and 5C are views provided to describe an analysis on a pose and a motion of an object according to an exemplary embodiment;

FIGS. 6A, 6B, 7A, 7B, and 7C are views provided to describe examples of an object which is photographed differently depending upon a motion;

FIGS. 8A and 8B are views provided to describe an example of a photo which is photographed when a plurality of objects have different motions;

FIGS. 9A, 9B, 10A and 10B are views provided to describe an example of a part of an object having a different motion according to an exemplary embodiment; and

FIG. 11 is a flowchart provided to describe a method for photographing an image according to an exemplary embodiment.

### DETAILED DESCRIPTION

The exemplary embodiments of the present disclosure may be diversely modified. Accordingly, specific exemplary embodiments are illustrated in the drawings and are described in detail in the detailed description. However, it is to be understood that the present disclosure is not limited to a specific exemplary embodiment, but includes all modifications, equivalents, and substitutions without departing from the scope and spirit of the present disclosure. Also, well-known functions or constructions are not described in detail since they would obscure the disclosure with unnecessary detail.

The terms “first”, “second”, and the like may be used to describe diverse components, but the components are not limited by the terms. The terms are only used to distinguish one component from the others.

The terms used in the present application are only used to describe the exemplary embodiments, but are not intended to limit the scope of the disclosure. The singular expression also includes the plural meaning as long as it does not differently mean in the context. In the present application, the terms “include” and “consist of” designate the presence of features, numbers, steps, operations, components, elements, or a combination thereof that are written in the specification, but do not exclude the presence or possibility of addition of one or more other features, numbers, steps, operations, components, elements, or a combination thereof.

In the exemplary embodiment of the present disclosure, a “module” or a “unit” performs at least one function or operation, and may be implemented with hardware, software, or a combination of hardware and software. In addition, a plurality of “modules” or a plurality of “units” may be integrated into at least one module except for a “module” or a “unit” which has to be implemented with specific hardware, and may be implemented with at least one processor (not shown).

Hereinafter, the present disclosure will be described in detail with reference to the accompanying drawings.

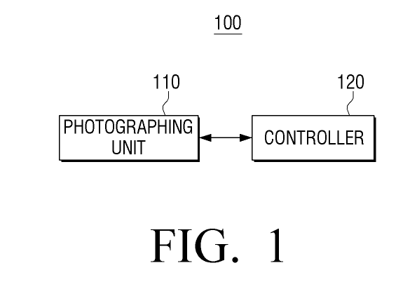

FIG. 1 is a block diagram illustrating a simple structure of an image photographing apparatus according to an exemplary embodiment.

Referring to FIG. 1, an image photographing apparatus 100 includes a photographing unit 110 and a controller 120. In this case, the image photographing apparatus 100 may be realized as various forms of electronic apparatuses having a camera function, such as, a digital camera specialized for photographing a moving image or a still image, a television (TV), an electronic bulletin board, an electronic table, a Large Format Display (LFD), a smart phone, a smart watch, a tablet Personal Computer (PC), a desktop PC, a laptop PC, and the like.

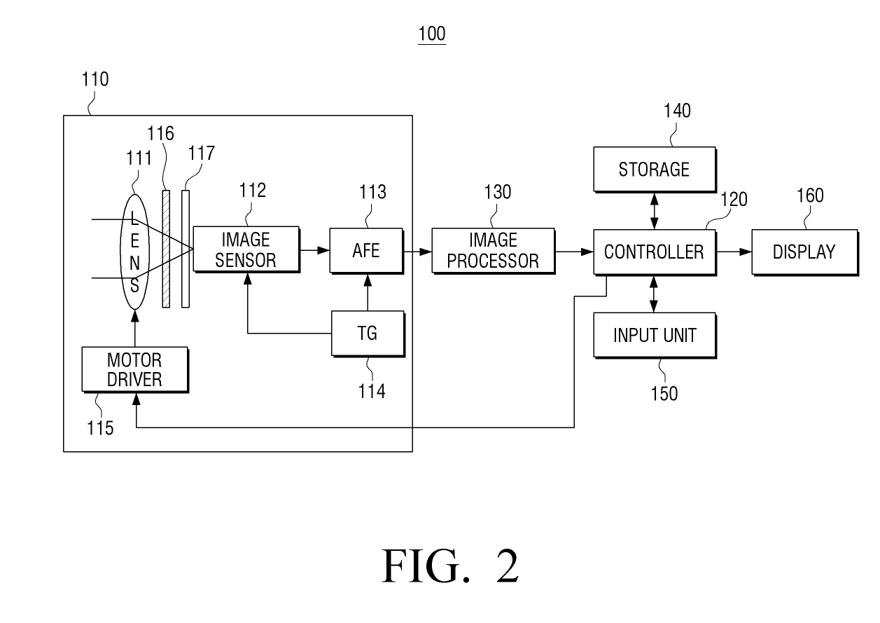

The photographing unit 110 photographs an image with an object therein. To be specific, the photographing unit 110 receives incident light reflected from the object and output an electronic signal by sensing the incident light. The structure and operations of the photographing unit 110 will be described below in further detail with reference to FIG. 2.

In the present exemplary embodiment, it is assumed that the photographing unit 110 photographs a plurality of objects. Herein, the objects refer to all objects photographed in a view angle of the photographing unit 110. In addition, at least one of the plurality of objects may have a different motion. In this case, a motion refers to a dynamic state or a static state of a photographed object, and may include all visible states where the object becomes bigger, becomes smaller, moves in forward, backward, upward, downward, right, and left directions with respect to the image photographing apparatus 100, rotates, or stops. The motion of the object includes a state where only a part of the object moves, as well as a state in which an entirety of the object moves.

The controller 120 controls respective components of the image photographing apparatus 100. To be specific, the controller 120 may control the components of the image photographing apparatus 100 which are used to photograph an object.

The controller 120 may set a parameter used in a photographing operation. To be specific, the controller 120 may set various parameters which affect the photographing operation. In this case, the parameter may include universal figures used in photography. For example, the parameter may include a focal distance, a shutter speed, a film speed (or sensitivity), an aperture openness (or F value represented as ‘F/#.’), existence or strength (Guide number: GN) of a strobe light (or flash), and the like. In this case, the controller 120 may set values of some or all of the settable parameters automatically. However, when a user manually sets some parameters to obtain a desired image effect, the controller 120 may set the remaining parameters.

The controller 120 determines a main object to be used as a reference for setting a parameter for a photographing operation from among a plurality of objects. To be specific, when setting a parameter to be used in the photographing operation, the controller 120 may determine a main object of which motion is reflected from among the plurality of objects. That is, the image photographing apparatus 100 may set a parameter for a photographing operation using a particular object as a reference as well as considering variation of a photographed image and a part of areas of the image.

In this case, the motion of object refers to information on an object which is recognized relatively with respect to the image photographing apparatus 100. That is, in response to a motion of the image photographing apparatus 100 for photographing the object existing together with the motion of the object, the motion of the object which is relative to the image photographing apparatus 100 is considered to set a parameter.

The controller 120 determines a main object by using characteristic information on the object. To be specific, the controller 120 may determine an object having characteristic information corresponding to characteristic information on a pre-stored object as the main object for setting a parameter.

The characteristic information on the object may be information for identifying the object. For example, the characteristic information may be person characteristic information for recognizing a face, a body, arms, and legs of a person object. In addition, the characteristic information may include characteristics of an appearance and motion of an animal.

The controller 120 may determine a main object according to a user selection. To be specific, in response to selecting one of the plurality of objects, the controller 120 may determine the selected object as the main object.

The controller 120 may determine a main object that the user wants by using various algorithms. For example, the controller 120 may designate or determine an object which is the largest object, or an object which is closest to the image photographing apparatus 100 from among the plurality of objects as the main subject to reflect a user intention of photographing the object in detail. In addition, the controller 120 may designate or determine an object which is photographed for the longest time as the main object so that an object which does not disappear from a range of a view angle and is fixed in a user desired direction, or an object that the image photographing apparatus 100 continuously photographs is determined as the main object. The controller 120 may also determine an object which was previously photographed as the main object to reflect a user intention of obtaining other photo of the object photographed in a different direction or at a different distance.

The controller 120 may analyze a motion of the object. To be specific, the controller 120 may analyze a speed at which the main object moves. The speed of the object may be calculated by using a frame rate in photographing the object and a moving distance of the object in frames.

In addition, the controller 120 may analyze the motions of the respective parts of the object. To be specific, the controller 120 may analyze an overall motion of the main object and a motion of some or all parts of the main object. For example, the controller 120 may analyze a motion of a wheel which rotates at high speed differently from a moving speed of a vehicle or a motion of moving arms of a running person.

The controller 120 sets a parameter used in the photographing operation based on the motion of the main object. To be specific, in response to the main object being determined, the controller 120 may analyze a motion of the determined main object and set a parameter which is suitable for the motion of the main object. In addition, the controller 120 may set a parameter suitable for the analyzed motion of each part of the main object. In this case, in response to the main object having different motions by respective parts, the controller 120 may set a parameter according to a predetermined condition. To be specific, the controller 120 may select only one part to be used as a reference for setting the parameter from among a plurality of moving parts of the main object or may set the parameter by using an average value of the entire motions. For example, the controller 120 may set the parameter based on a speed of a part which moves at the highest speed from among the parts that move at other different speeds. In addition, the controller 120 may set a part which occupies the largest photographing portion from among the parts of the main object as the reference for setting the parameter.

In this case, an operation of setting a suitable parameter may be performed based on a value calculated from an analysis result on the motion according to a pre-stored algorithm. In addition, the parameter may be set automatically or controlled through a Look-Up Table more rapidly. The pre-stored algorithm may belong to at least one of the Auto Focusing (AF) function or Auto Exposure (AE) function.

In general, a camera raises a shutter speed to correspond to a speed of the object to avoid an occurrence of blurring on a moving object in a photo due to long exposure of a sensor and sets the parameter to obtain a clear photo by opening an aperture largely and raising ISO sensitivity.

Meanwhile, the controller 120 may set the parameter based on the speed analyzed from the motion of the main object. As described above, the controller 120 may set the parameter by using a table value mapped onto a predetermined speed section or may set the parameter as a value obtained by a predetermined particular formula.

The controller 120 may track the motion of the object. To be specific, the controller 120 may track the motion of the main object or the motions of the plurality of objects through signal-processing of image data corresponding to an image formed on an image sensor.

Upon completion of the analysis on the motion of the object, the controller 120 may provide the analyzed result visually. To be specific, the controller 120 may display in a current frame the motion of the object in a form of an afterimage of in a previous frame, or may display a frame of the object in which the object may maneuver.

The controller 120 may control the photographing unit 110 to photograph the plurality of objects by using the set parameter. To be specific, in response to a photographing parameter suitable for the main object being set based on the motion of the main object, the controller 120 may control the photographing unit 110 to perform the photographing operation by using the set parameter.

The controller 120 may be realized in various methods. For example, the controller 120 may be at least one of a processor, an Application-Specific Integrated Circuit (ASIC), an embedded processor, a microprocessor, hardware control logic, hardware Finite State Machine (FSM), and a Digital Signal Processor (DSP). In this case, a control interface (not shown) may be used for communication between the controller 120 and other function units of the image photographing apparatus 100. In addition, the control interface (not shown) may be used for external communication of the image photographing apparatus 100.

According to the above-described exemplary embodiment, the image photographing apparatus 100 performs the photographing operation through the parameter setting by considering a motion of a particular object from among a plurality of objects in a photo, thereby obtaining a photo which is more suitable for a main object and has a high image quality.

FIG. 2 is a block diagram illustrating a detailed structure of the image photographing apparatus 100 of FIG. 1.

Referring to FIG. 2, the image photographing apparatus 100 includes the photographing unit 110, the controller 120, an image processor 130, a storage 140, an input unit 150, and a display 160. The photographing unit 110 may include a lens 111, an image sensor 112, an Analog Front End (AFE) 113, a Timing Generator (TG) 114, an aperture 116, and a shutter curtain or shutter 117.

The lens 111 is a component into which light reflected to an object falls and includes at least one of a zoom lens for controlling a view angle to be reduced or enlarged depending upon a focal distance and a focus lens for focusing on an object. The lens 111 may be accommodated in a body tube (not shown) of the image photographing apparatus 100, and moved by a driving signal from a motor driver 115 to control a focus. In addition, the body tube includes the shutter 117 and the aperture 116, which control an amount of incident light admitted into the lens 111, respectively through the driving motor 115.

The image sensor 112 is a component in which an image of an object that passed through the lens 111 is formed. The image sensor 112 includes a plurality of pixels arranged in a matrix form. The plurality of pixels may form a Bayer pattern. Each of the plurality of pixels accumulates photocharges according to the incident light and outputs an image according to the photocharges in the form of an electronic signal. The image sensor 112 maybe realized as a Complementary Metal Oxide Semiconductor (CMOS) or may be realized as a Charge Coupled Device (CCD). According to an exemplary embodiment, the plurality of pixels may include a plurality of phase difference pixels.

Although not shown, the image sensor 112 may include a photo diode (PD), a transmission transistor (TX), a reset transistor (RX), and a floating diffusion node (FD). The PD generates and accumulates the photocharges corresponding to an optical image of an object. The TX transmits the photocharges generated by the PD to the FD in response to a transmission signal. The RX discharges the photocharges stored in the FD in response to a reset signal. The photocharges stored in the FD are outputted before the reset signal is applied, and a Correlated Double Sampling (CDS) image sensor performs a CDS processing operation. An Analog-to-Digital Converter (ADC) converts a CDS-processed analog signal into a digital signal.

The AFE 113 samples and digitizes the electronic signal on the object, outputted from the image sensor 112. The AFE 113 is controlled by the controller 120.

The TG 114 outputs a timing signal for reading out pixel data of the image sensor 112. The TG 114 is controlled by the controller 120.

However, the AFE 113 and the TG 114 may be replaced with other components. In particular, in case of the image sensor 112 being realized as a CMOS type, the AFE 113 and the TG 114 may be optional.

The motor driver 115 drives a focusing lens to control a focus according to the control of the controller 120.

The aperture 116 controls the amount of light admitted into the image sensor 112. To be specific, the aperture 116 may control a caliber for controlling the amount of light admitted into the image sensor 112 through the body tube.

The shutter 117 controls a time that an image is formed in the image sensor 112. To be specific, the shutter 117 may allow the light to pass for a predetermined time through an operation of opening/closing the shutter 117. FIG. 2 exemplifies a mechanical shutter, but an electronic shutter for electronically controlling the image sensor may be used as an alternative.

In addition, in FIG. 2, the aperture 116 and the shutter 117 are illustrated as distinct components, but the aperture 116 and the shutter 117 may be realized as single component.

The image processor 130 performs an image-processing operation with respect to raw image data according to the control of the controller 120 and records the data in the storage 140. In addition, the image processor 130 transmits the image-processed data in the storage 140 to the display 160.

In case of an Auto-Focusing operation using a phase difference, the image processor 130 separates a signal for generating an image (signal read out of a normal pixel) and a signal for calculating a phase difference (signal read out of a phase difference pixel) from among signals which were outputted from the image sensor 112 and sampled by the AFE 113, in order to perform the Auto-Focusing operation at high speed by rapidly calculating the phase difference using the signal for calculating a phase difference concurrently with generating an image such as a live view.

However, the image photographing apparatus 100 according to above-described various exemplary embodiments is not limited to the Auto-Focusing method using the phase difference pixel. That is, the image photographing apparatus 100 according to above-described various exemplary embodiments may further include a component for performing a contrast Auto-Focusing operation.

The image processor 130 processes the raw image data and converts the processed data into Y/Cb/Cr data. A pixel defect of the raw image data is corrected by a correction circuit (not shown). The correction circuit corrects the pixel defect with reference to a correction table, and the correction table includes an address of a defective pixel. The correction circuit corrects the pixel corresponding to the address from among surrounding pixels.

The image processor 130 includes an Optical Black (OB) clamping circuit (not shown) for determining a black level of an image. The image sensor 112 has an OB area, detects a signal average value in the OB area, and determines a black level according to a difference in respective pixel values.

The image processor 130 performs a sensitivity rate adjustment for respective colors by using a sensitivity adjustment circuit (not shown). The sensitivity adjustment circuit adjusts the sensitivity of red (R), green (G), and blue (B) colors under standard illuminant. In general, the sensitivity adjustment circuit fixes or sets a gain value of the G color to be ‘1’ and adjusts the sensitivity of the R and B colors to correspond to the gain value.

In case of a still image, the sensitivity adjustment circuit adjusts the sensitivity and outputs the image data through an output buffer. In this case, an image is generated in an interlace method, and thus, an immediate post-processing operation is not possible. By contrast, in case of a live view image, an image is generated in a progressive method, and thus, the post-processing operation may be performed immediately.

The image processor 130 performs a skip-readout operation of reading out a part of pixel lines and skipping the other pixel lines by using a horizontal skip-readout circuit (not shown), and thus, the number of pixels of a raw image is reduced.

The image processor 130 adjusts White Balance (WB) with respect to the image data by using a WB adjustment circuit (not shown). For example, in case of photographing a white object, the white object may be not displayed in white since spectral distribution of illumination light varies depending upon a photographing environment. Accordingly, the WB adjustment circuit assigns different gain values to R, G, and B pixels and adjusts a signal level. In general, the WB adjustment circuit fixes the gain value of the G pixel to be ‘1’ and adjusts the signal levels of the R and B pixels to correspond to the gain value.

In addition, the image processor 130 performs a gamma correction with respect to the image data. By the gamma correction, gradation conversion is executed to correspond to an output of the display 160.

In addition, the image processor 130 generates a common color image signal having three colors for one pixel from a Bayer signal having one color for one pixel by using a color interpolation circuit (not shown).

The image processor 130 performs color space conversion corresponding to an output and color correction by using a color conversion/color correction circuit (not shown). According to the need, a LookUp Table (LUT) may be used. After the color conversion/color correction operation, the image data is converted into the Y/Cb/Cr data, where Y stands for a luma component, Cb and Cr are the blue-difference and red-difference chroma components, respectively.

The image processor 130 converts resolution by using a resolution conversion circuit (not shown) to adjust a size.

The image processor 130 processes a space filter with respect to the image data by using a space filter circuit (not shown). Edge enhancement with respect to a Y signal is performed, and a Low Pass Filter (LPF) processing operation of a Cb/Cr signal is performed.

The image processor 130 performs the skip-readout operation with respect to the Cb/Cr signal by using a Cb/Cr skip-readout circuit (not shown) and converts the signal into the image data of Y/Cb/Cr 4:2:2. The image data is outputted through the output buffer and recorded in the storage 140 through a bus.

In case of a still image, the readout operation may be performed in the interlace method. In this case, an adjacent pixel line does not exist, and thus, the color interpolation may be not performed directly. Accordingly, upon completion of a pre-processing operation, an order of pixel lines is adjusted and stored in the storage 140 in a progressive form through the output buffer. The image data is read and inputted into the image processor 130 through an input buffer (not shown).

However, the exemplary embodiment regarding the still image is not limited to the interlace method and may be realized to read out an image in the progressive method.

Meanwhile, in case of the still image, a preview image or a thumbnail image for displaying an image in a small size needs to be generated after the photographing operation. Such image is generated by omitting data of a part of pixels as in the skip-readout.

The image processor 130 interpolates a phase difference part to have a normal pixel value by using an AF signal interpolation circuit (not shown). The phase difference pixel is located between the normal pixels, and thus, using the part without change may cause resolution deterioration. Accordingly, the interpolation is performed by using the adjacent normal pixels.

Meanwhile, a signal of the phase difference signal separated from a separation circuit (not shown) is recorded in the storage 140 through a first bus. All of the plurality of pixels are read out and separated, and thus, respective phase difference pixel signals are accumulated in the storage 140 for a short time.

The stored phase difference pixel signals are inputted into a phase difference calculation circuit (not shown) through the first bus. The phase difference calculation circuit calculates a phase difference between the phase difference pixels and calculates a moving direction and a movement amount of a focus lens. The calculated movement amount is recorded in a register in the phase difference calculation circuit temporarily and read by the controller 120, or a Central Processing Unit (CPU).

A JPEG codec compresses the Y/Cb/Cr data. The compressed image data is recorded or stored in the storage 140. The image generating operation is completed as the controller 120 reads the compressed image data recorded in the storage 140 and records the compressed image data in a memory card (not shown).

The controller 120 controls the entire components of the image photographing apparatus 100. The function and operations of the controller 120 have been described above in connection with the controller 120 in FIG. 1.

The controller 120 acquires the raw image data by controlling the photographing unit 110 and displays a live view image in the display 160 by controlling the image processor 130. Specially, the controller 120 may control the display 160 to visually display information on a motion or pose of the main object.

The controller 120 includes hardware components, such as, a CPU, cache memory, and the like, and software elements such as an operating system, an application for performing a particular purpose, and the like. A control command for respective components of the image photographing apparatus 100 is read from the memory according to a system clock, and an electronic signal is generated according to the read control command to operate the hardware components.

The storage 140 stores an image or is used in an imaging operation by the CPU. Specially, the storage 140 may store images of a photographed object accumulated by frame. In addition, the storage 140 may store an algorithm for recognizing a main object or store information for determining the main object based on the characteristic information of the object.

According to an exemplary embodiment, a Double Data Rate Synchronous Dynamic Random Access Memory (DDR SDRAM) may be used. The DDR SDRAM may allow both of a rising edge and a falling edge of the system clock to perform an output thereby increasing the output by two times as compared with an output of the rising edge.

In case of the storage 140 including a flash memory (not shown), the storage 140 stores a firmware program, diverse alignment information corresponding to a specification of the image photographing apparatus 100, setting information of the image photographing apparatus 100 by a user input, a photographed image file, and the like.

In case of the storage 140 further including a memory card (not shown), the memory card may be detachable from the image photographing apparatus 100. The memory card may store the photographed image file.

The input unit 150 receives a user input. To be specific, the input unit 150 may include at least one button. In addition, the input unit 150 may be realized as a touch panel in the display 160 to receive a user touch input.

The at least one button (not shown) may be realized as a push-type button or a touch-type button on a front surface, a side surface, or a rear surface of a housing of the image photographing apparatus 100 and may include at least one of a power/lock button, a shutter button, a menu button, a home button, a back button, and a search button. In response to the button being pressed, a corresponding signal is transmitted to the controller 120, and the controller 120 may control the operation of the image photographing apparatus 100 according to the received signal.

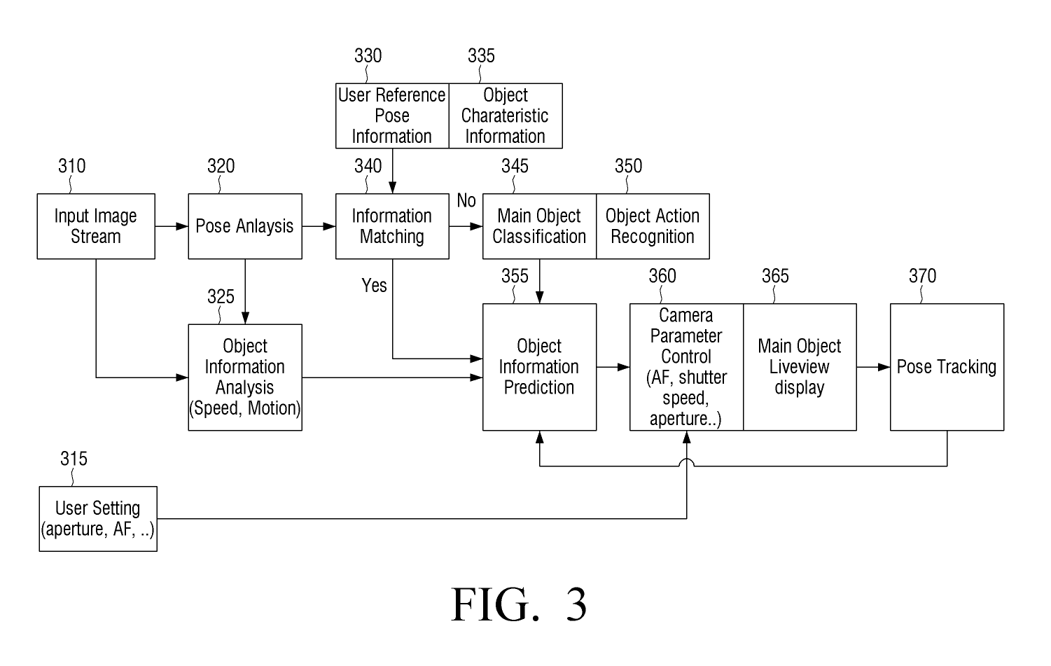

FIG. 3 is a flow diagram provided to describe an image photographing apparatus by respective functions according to an exemplary embodiment.

Referring to FIG. 3, a series of images are inputted by the photographing operation with respect to the plurality of objects (310). In addition, a user input for setting at least one parameter used in the photographing operation may be received (315).

A pose of a main object is analyzed using the photographed images (320). In addition, the photographed images are used in analyzing a motion (325).

The image photographing apparatus 100 stores user reference pose information and/or object characteristic information defined by the user (330 and 335, respectively). The user reference pose information and/or object characteristic information are compared with an analysis result on the pose (340).

In response to a matched pose of the main object being analyzed as the information is being compared, a next motion of the object is anticipated using motion information of the object and the pose of the main object (355).

In response to a matched pose not being analyzed from the information of the image photographing apparatus 100, the main object and the pose are analyzed through a main object analysis, and object action recognition as a distinct algorithm (345 and 350, respectively). Subsequently, a next motion of the object is anticipated by using the analyzed pose of the main object and the motion information of the subject (355).

In response to the motion information on the object in the photographing operation being obtained from the anticipated result, a parameter of a camera is set based on the obtained motion information (360). Simultaneously, a live view of the photographed subjects may be displayed, and the analyzed motion information and/or information on the anticipated motion of the main object may be displayed in the display 160 visually.

The image photographing apparatus 100 tracks the pose of the main object continuously (370). Pose information on the tracked main object is provided as a feedback to anticipate a next motion (355).

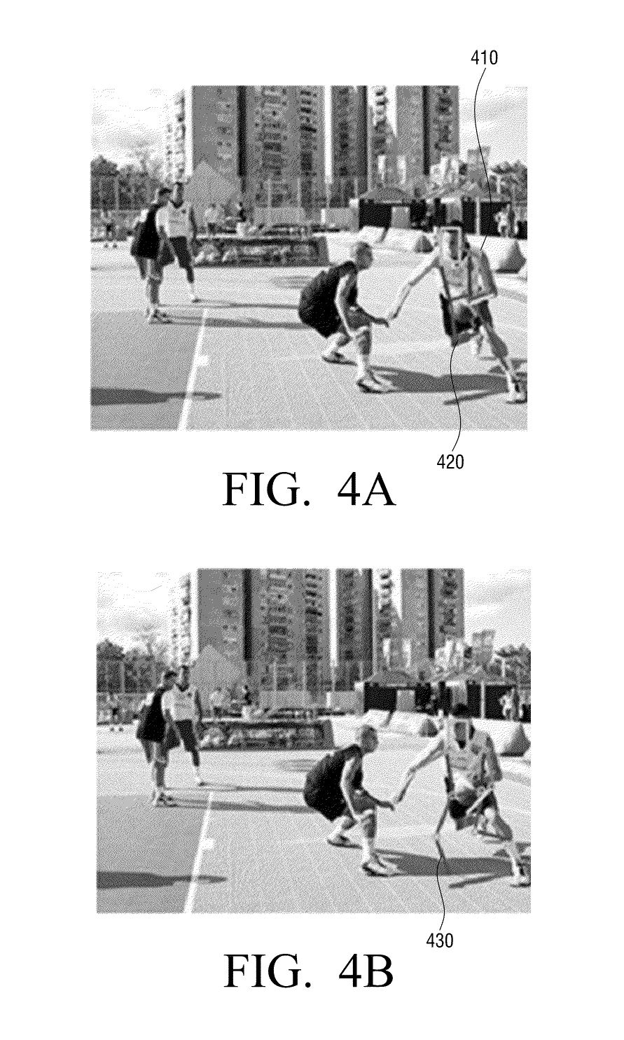

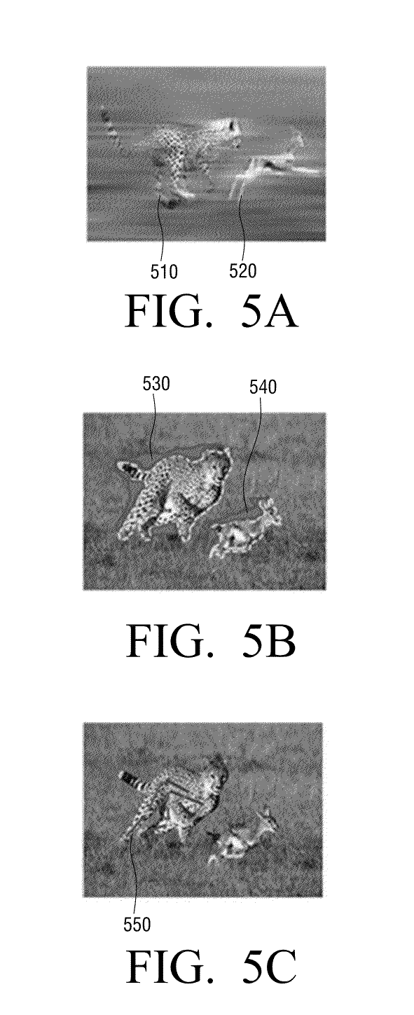

FIGS. 4A, 4B, 5A, 5B, and 5C are views provided to describe an analysis on a pose and a motion of an object according to an exemplary embodiment.

Referring to FIGS. 4A and 4B, there are provided images of a basketball court, a plurality of people playing a basketball game, several structures, apartment houses, sky, and trees.

In this case, the main object is a player 410 dribbling a ball in a location closest to the image photographing apparatus 100. A pose of the main object, the player 410 is analyzed. As illustrated in FIG. 4A, the analyzed pose may be displayed in a line and a FIG. 420 along parts which moves by a bone structure, such as, a face, a body, upper arms, forearms, thighs, calves, lower legs, and feet.

The image photographing apparatus 100 may anticipate a motion of the main object, and an anticipated pose 430 of the main object may be displayed as the moved line and FIG. 420 as illustrated in FIG. 4B.

Referring to FIGS. 5A, 5B and 5C, there are provided images of a cheetah 510 running fast to hunt a gazelle 520. FIG. 5A is an image photographed according to an unsuitable parameter setting. In FIG. 5A, blurring occurs on the objects and background along the moving direction.

FIGS. 5B and 5C are images photographed according to the parameters suitable for the motion of the main object, the cheetah 510. In FIG. 5B, the edges of the cheetah 510 and the gazelle 520 are displayed in dotted lines by tracking with respect to the objects, and a location of the objects in the previous frame is displayed in green after images 530, 540. The image photographing apparatus 100 may calculate a speed based on a pixel distance where the objects moved in the frames and set the parameter to be used in the photographing operation.

In FIG. 5C, the pose of the cheetah 510, the main object, is analyzed, and the structures of the body and legs are displayed in a form of a segment 550 along with the object, the cheetah 510.

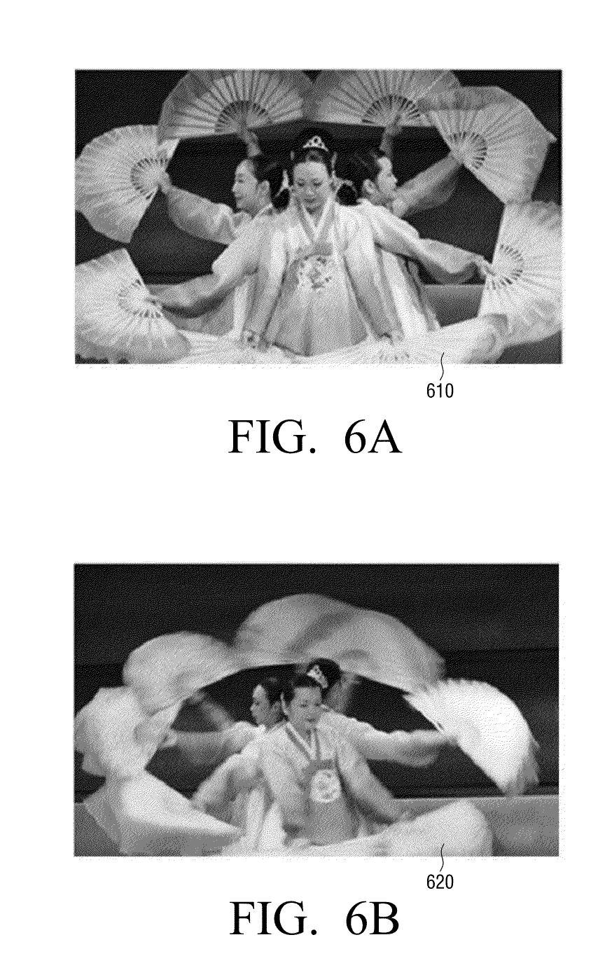

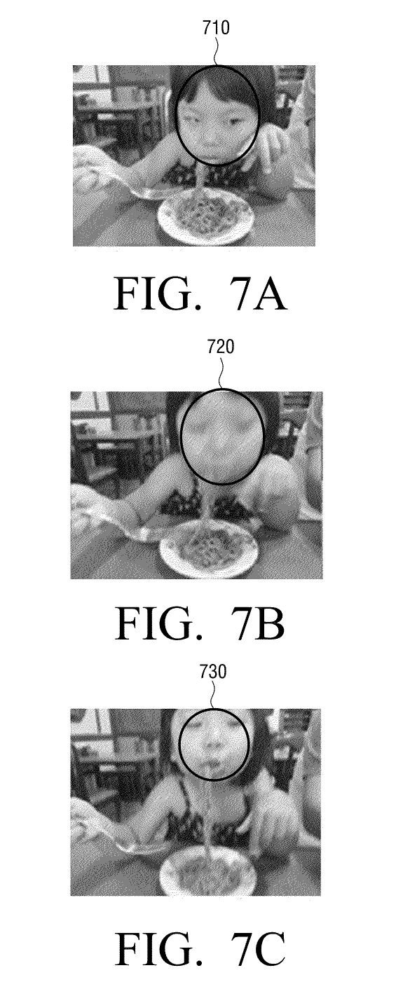

FIGS. 6A, 6B, 7A, 7B, and 7C are views provided to describe examples of an object which is photographed differently depending upon a motion.

In FIG. 6A, there is provided an image of people standing back to back, fans held by the people, and the background. In this case, the fans 610 that are still objects are photographed clearly.

In FIG. 6B, there is provided an image where the people gyrate, and the fans rotate in a circle. In this case, the fans 620 that are the moving objects are photographed blurredly.

Referring to FIGS. 7A, 7B, and 7C, there are provided three respective images of a girl having food. In FIG. 7A, from among the images photographed without parameter change, the girl's face 710 is photographed clearly. In FIG. 7B, the girl's face 720 is photographed blurredly as the face moves fast, and in FIG. 7C, the girl's face 730 is photographed slightly blurredly.

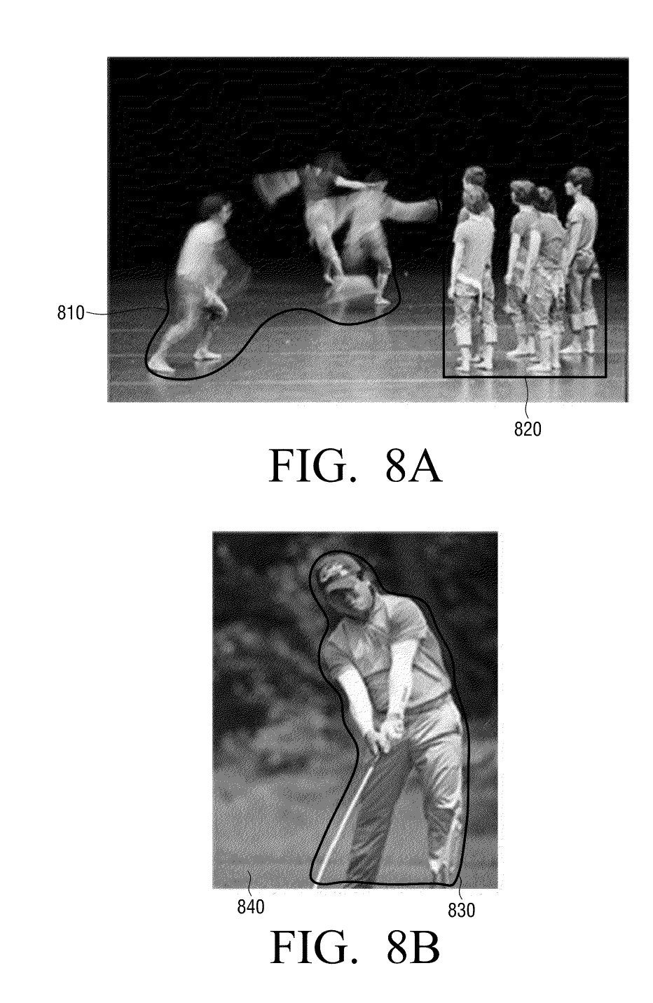

FIGS. 8A and 8B are views provided to describe an example of a photo which is photographed when a plurality of objects have different motions.

Referring to FIG. 8A, there is provided an image where three people performing B-boying 810 move fast, and the other five people 820 stand nearby.

In case of the existing AE function of calculating an average motion of the entire are of a photographed image or considering only a motion of some divided area, an object moving fast is photographed unclearly as in FIG. 8A.

In FIG. 8B, there is provided an image where a person 830 swinging a golf club to hit a golf ball is photographed with background 840.

The background 840 remains still unlike the person's body which moves fast, but the image is photographed according to the parameter set for the person 830, that is, the main object, and thus, the main object is photographed clearly.

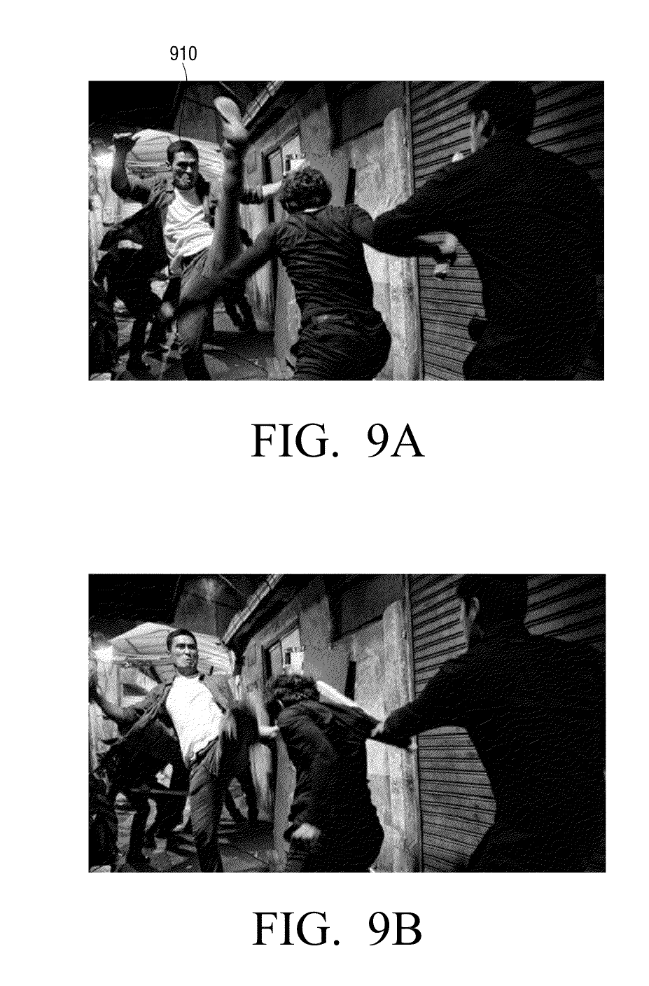

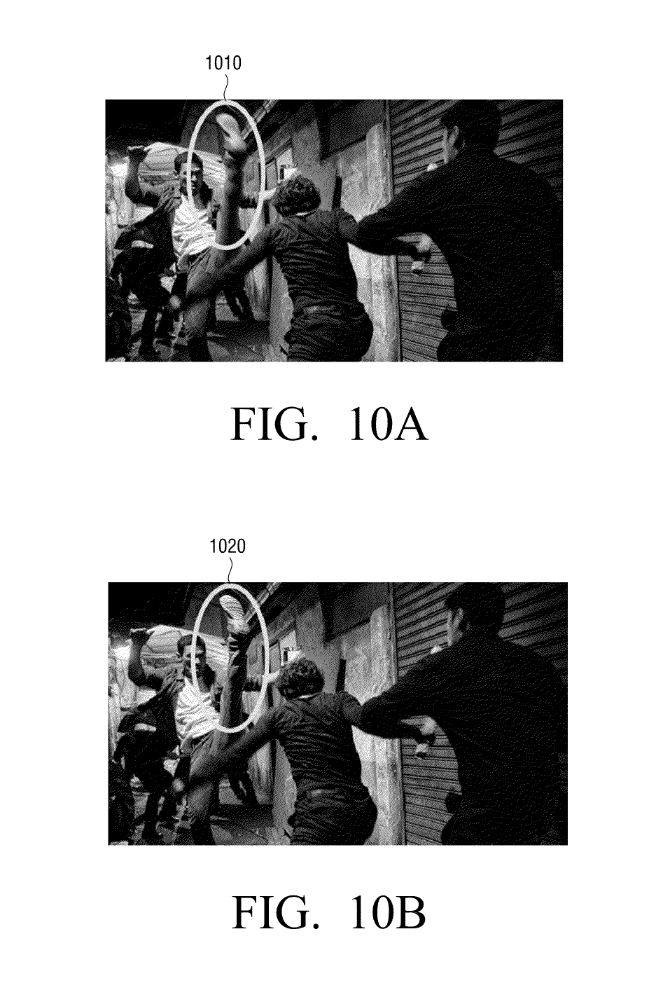

FIGS. 9A, 9B, 10A and 10B are views provided to describe an example of a part of an object having a different motion according to an exemplary embodiment.

In FIGS. 9A and 9B, there are provided two sequential images where a main object, a person 910 performing a kicking action from among several objects, moves faster than the other people.

Referring to FIGS. 10A and 10B, a leg 1010 that is a part of the body of the moving main object, the person 910, moves faster than the other parts of the body, and thus, the leg is photographed blurredly as in FIG. 10A.

However, in FIG. 10B, the parameter is set with reference to the leg 1020 of the main object, the person 910, and the whole body of the main object, the person 910 is photographed clearly.

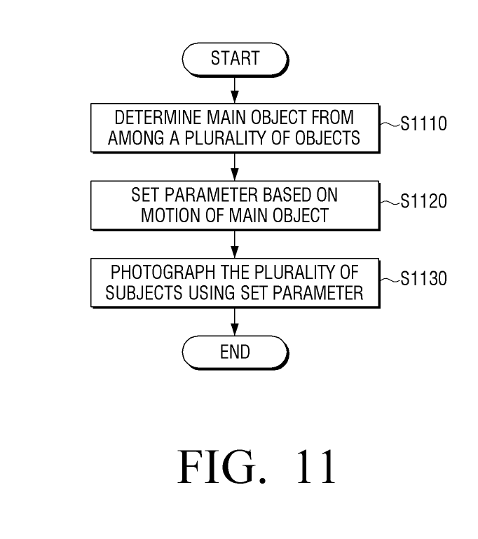

FIG. 11 is a flowchart provided to describe a method for photographing an image according to an exemplary embodiment.

Referring to FIG. 11, a main object is determined first from among a plurality of objects (S1110). To be specific, a main object for setting a parameter to be used in a photographing operation may be determined from among the plurality of objects to be photographed. In this case, the main object may be an object corresponding to characteristic information on a pre-stored object. Alternatively, the main object may be one of an object which is the largest object, an object which is photographed for the longest time, an object which is closest to the image photographing apparatus, an object which is located in the centermost position, and an object which is previously photographed from among the plurality of objects. Meanwhile, the main object may be determined according to a user input for selecting a main object.

Subsequently, a parameter is set based on a motion of the determined main object (S1120). To be specific, the parameter may be set by analyzing a speed at which the main object moves. In addition, the parameter may be set based on a motion of the main object anticipated at a point of time when the object is photographed by tracking with respect to the motion of the main object. In addition, the parameter may be set according to a condition which is predetermined by considering a motion of a whole body of the main object and different motions of a part of the main object.

The plurality of objects are photographed using the set parameter (S1130).

Meanwhile, according to the exemplary embodiments, the method for photographing an image may further include an operation of visually providing a user with information on a motion or pose of a plurality of objects to be photographed so that the user is able to recognize a state of the objects more easily.

According to the above-described method, a parameter is set automatically to be suitable for a main object even though there are other objects having a different motion, and thus, an image where the main object is photographed clearly may be provided.

In addition, according to an exemplary embodiment, the method for photographing an image may be realized in the image photographing apparatus of FIGS. 1 and 2 and diverse electronic apparatuses having other photographing functions. In addition, the method may be realized as at least one program for executing the photographing method, and the program may be stored in a computer readable recording medium.

The non-transitory computer readable medium does not mean a medium storing data for a short period such as a register, a cache, a memory, or the like, but means a machine-readable medium semi-permanently storing the data. Specifically, various applications or programs described above may be stored and provided in the non-transitory computer readable medium such as a compact disc (CD), a digital versatile disc (DVD), a hard disk, a Blu-ray disk, a universal serial bus (USB), a memory card, a read-only memory (ROM), or the like.

Hereinabove, although the exemplary embodiments of the present disclosure have been shown and described, it should be understood that the present disclosure is not limited to the disclosed embodiments and may be variously changed by those skilled in the art without departing from the spirit and the scope of the present disclosure. Therefore, the present disclosure should be construed as including all the changes, equivalents, and substitutions included in the spirit and scope of the present disclosure.

What is claimed is:

1. An image photographing apparatus comprising:
a photographing unit configured to photograph a plurality of objects; and
a controller configured to determine a main object to be used as a reference for a photographing operation from among the plurality of objects, set a parameter for the photographing operation based on a motion of the main object, and control the photographing unit to photograph the plurality of objects using the parameter.

2. The image photographing apparatus as claimed in claim 1, wherein the controller analyzes a speed at which the main object moves and sets the parameter based on the speed analyzed by the controller.

3. The image photographing apparatus as claimed in claim 1, wherein the parameter comprises at least one of a shutter speed, an aperture openness (F/#), and sensitivity (ISO).

4. The image photographing apparatus as claimed in claim 1, wherein the controller performs tracking with respect to the motion of the main object and sets the parameter based on the motion of the main object anticipated at a point of time when the plurality of objects are photographed based on the tracking.

5. The image photographing apparatus as claimed in claim 1, wherein the controller determines an object corresponding to characteristic information on a pre-stored object from among the plurality of objects as the main object.

6. The image photographing apparatus as claimed in claim 1, wherein the controller determines at least one of a largest object, an object photographed for a longest time, an object closest to the image photographing apparatus, an object located in a centermost position, and an object previously photographed from among the plurality of objects as the main object.

7. The image photographing apparatus as claimed in claim 1, wherein in response to selecting one of the plurality of objects, the controller determines the object selected as the main object.

8. The image photographing apparatus as claimed in claim 1, wherein the controller sets the parameter according to a predetermined condition based on different motions of respective parts of the main object.

9. The image photographing apparatus as claimed in claim 1, wherein the controller provides information on at least one a motion and a pose of the main object visually.

10. A method for photographing an image with an image photographing apparatus, the method comprising:
determining a main object to be used as a reference for a photographing operation from among a plurality of objects;
setting a parameter for the photographing operation based on a motion of the main object; and
photographing the plurality of objects using the parameter.

11. The method as claimed in claim 10, wherein setting a parameter comprises analyzing a speed at which the main object moves and setting the parameter based on the speed analyzed.

12. The method as claimed in claim 10, wherein the parameter comprises at least one of a shutter speed, an aperture openness (F/#), and sensitivity (ISO).

13. The method as claimed in claim 10, wherein setting a parameter comprises performing tracking with respect to the motion of the main object and setting the parameter based on the motion of the main object anticipated at a point of time when the plurality of objects are photographed by the tracking.

14. The method as claimed in claim 10, wherein determining a main object comprises determining an object corresponding to characteristic information on a pre-stored object from among the plurality of objects as the main object.

15. The method as claimed in claim 10, wherein determining a main object comprises determining at least one of a largest object, an object photographed for a longest time, an object closest to the image photographing apparatus, an object located in a centermost position, and an object previously photographed from among the plurality of objects as the main object.

16. The method as claimed in claim 10, wherein in response to selecting one of the plurality of objects, determining a main object further comprises determining the object selected as the main object.

17. The method as claimed in claim 10, wherein setting a parameter comprises setting the parameter according to a predetermined condition based on different motions of respective parts of the main object.

18. The method as claimed in claim 10, further comprising providing information on at least one of a motion and a pose of the main object visually.
